(19) United States
(12) Patent Application Publication
(10) Pub. No.: US 2022/0146700 A1
(43) Pub. Date: May 12, 2022

(54) SEISMIC ACQUISITION SYSTEM AND METHOD FOR SEABED MINERAL EXPLORATION

(71) Applicant: EQUINOR ENERGY AS, Stavanger (NO)

(72) Inventor: Ketil HOKSTAD, Trondheim (NO)

(21) Appl. No.: 17/434,250

(22) PCT Filed: Mar. 6, 2019
(86) PCT No.: PCT/NO2019/000006

§ 371 Date: Aug. 26, 2021

(51) Int. Cl. G01V 1/38; G01V 1/30

(52) U.S. Cl. CPC G01V 1/3808; G01V 1/306; G01V 2210/1423; G01V 2210/1293; G01V 2210/121

(57) ABSTRACT

A seismic survey system for prospecting for sub-sea minerals including a first vessel towing a first seismic source and a seismic detector and a second vessel towing a second seismic source. The seismic detector is arranged to receive acoustic signals resulting from the reflection and/or refraction by the sea bed of acoustic signals emitted from both the first and second seismic sources.

The invention relates to a seismic surveying system for use in surveying the seabed and relatively shallow depths below the seabed when exploring for sub-sea mineral deposits, for example sulphides and particularly metal sulphides. The invention also extends to a corresponding method.

The current focus on renewable energy sources and electrification has lead to a large future demand for metals. This need for metals has driven an increasing interest for seabed minerals. Minerals known to be present at or near the seabed of the deep oceans contain valuable metals, such as copper, lead and zinc, mainly in the form of metal sulphides.

Some countries (e.g. Norway, the UK, Portugal, Brazil, Russia and Papua New Guinea) have deep-sea mineral resources inside exclusive economic zones (EEZ). However, most resources are in international waters, administrated by the International Seabed Authority (ISA). The ISA licensing system is such that licences for up to 10,000 km² exploration areas can be granted for 7 years. Half of the area must be relinquished after 4 years.

Exploration takes place on (at least) two different scales: (i) the regional scale (where to access) and (ii) the prospect scale (where to drill).

On the regional scale, the important question is where to obtain and secure acreage. On the prospect scale, the focus is where to drill an exploration well (the same principles apply to both petroleum and seabed mineral exploration).

Seabed mineral deposits are usually associated with precipitation from hydrothermal vents, mainly those known as black smokers. Metal sulphides are discharged when hot hydrothermal water meets the cold water of the ocean.

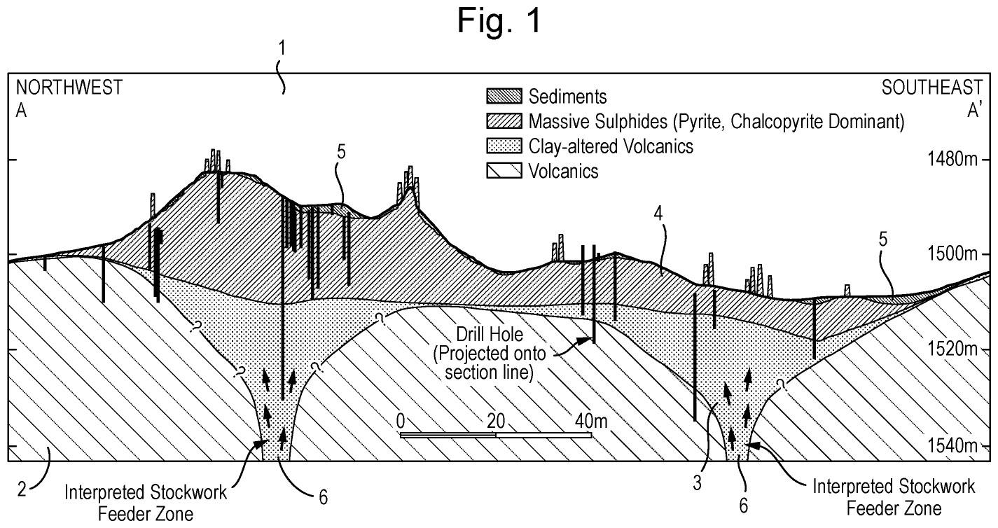

Due to the nature of the hydrothermal circulations, and their discharge via vents, seabed mineral deposits are usually small, typically 100-500 m in radius and located in deep water (1500-4000 m water depth). An example is shown in FIG. 1. At present, about 700 vents are known on the seabed, most of them located at or near the crustal plate boundaries.

Research and exploration studies on hydrothermal seabed vents have mainly been focused on detailed studies at known sites, using autonomous underwater vehicles (AUV) and remotely operated underwater vehicles (ROV), carrying a variety of geophysical sensors.

These exploration tools are suitable at the prospect scale. However, the limited range of AUVs and ROVs means that they are not suitable for exploration on the regional scale. There is therefore a need for alternative methods and preferably for such methods that are fast and/or cost-effective. The inventors have identified that such methods should preferably be based on towed shipborne geophysical sensors. However, known site survey vessels that are designed and built for near-surface mapping, whilst being much less expensive to operate than full seismic vessels, have short seismic streamers which render them unsuitable for this task.

According to a first aspect of the present invention there is provided a seismic survey system for prospecting for sub-sea minerals comprising: a first vessel having associated therewith a first seismic source and a seismic detector; and a second vessel having associated therewith a second seismic source; wherein the seismic detector is arranged to receive acoustic signals resulting from the reflection and/or refraction by the sea bed of acoustic signals emitted from both the first and second seismic sources.

Thus, the invention provides a new survey design, which may be based on a conventional (lower cost) site-survey vessel used together with a second source vessel, also referred to here as a ‘chase boat’. This provides an effective design to enable the obtaining of both short-offset reflection data (using the first source) and far offset refraction data (i.e. resulting from head waves, as explained below, using the second source). The invention is primarily (though not exclusively) intended for use where there is a target depth from the seabed to approximately 1000 m below the seabed.

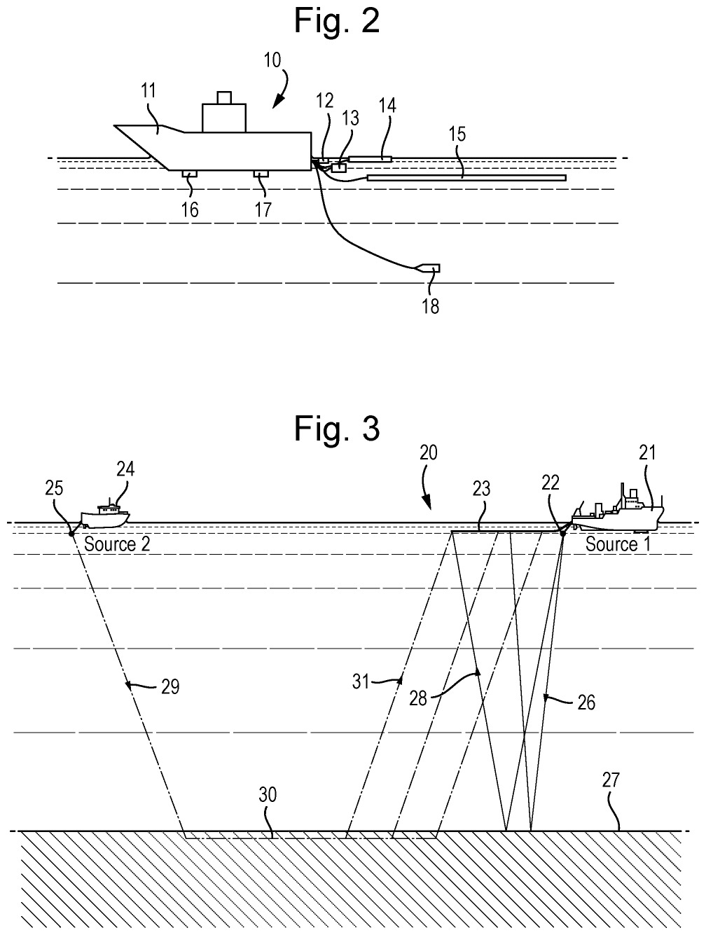

Although any suitable seismic detector may be employed, it is preferably a streamer (seismic receiving cable) comprising a plurality of hydrophones towed by the first vessel, as known in the art. As noted above, the first vessel is preferably a site-survey vessel (a type of vessel well known in the art). The rationale for the use of a site-survey vessel for this purpose is as follows:
Site-survey vessels are designed and built for shallow, high-resolution imaging. They are equipped with relatively short seismic streamers (up to 1500 m). They may also be provided with a sub-bottom profiler, multi-beam echo sounder, and/or side-scanning sonar. An example of such a vessel is shown schematically in FIG. 2. They are conventionally used to map geo-hazards (shallow gas) near the seabed.
Site-survey vessels are significantly cheaper to operate than standard seismic vessels (typically around half the cost of a 2D seismic vessel, and a third of the cost of a 3D seismic vessel)
For targets near the seabed and in deep water, seismic velocity analysis is not a significant problem. This is because the root mean square velocity is mostly dominated by the acoustic velocity of the water, which is known. Multiple-attenuation is also not a significant issue with deep water and shallow targets.
The highest spatial resolution in seismic imaging is obtained from zero-offset (normal incidence) reflection data, so a short streamer is sufficient for this purpose.

The seismic detector is preferably arranged to detect acoustic signals emitted by the first source and reflected by the sea bed to the seismic detector. Likewise, it is preferably arranged to detect acoustic signals emitted by the second source and propagated along the sea bed as head waves prior to detection by the seismic detector.

The firing of the first and second seismic sources is preferably synchronized. The two sources may be fired alternately (flip-flop operation); however, it is preferred for the first and second seismic sources fire simultaneously. Simultaneous shooting gives denser source spacing and/or higher operational efficiency.

The second vessel is preferably located behind the first vessel in the direction of travel thereof. With the streamer being towed behind the first vessel where the first source is located, reflection and refraction events (respectively resulting from the first and second seismic sources) will arrive with opposite dips in the seismic records, such that separation of reflected and refracted data become easy, even when the sources are fired simultaneously. This is because the reflection data and the (refracted) head-wave data will be recorded with opposite slopes, such that separation of data in the frequency-wavenumber (FK) domain is straight forward. (Slope here refers to the slope of an event recorded in a seismogram, mathematically the slope is dt/dx.)

The distance between the first and second vessels may be selected/adjusted as required to ensure that suitable refracted (head) waves are detected and will depend on, inter alia, water depth. However, the second vessel is preferably at least a distance of 1.5×the water depth behind the first vessel. Preferably, it is less than three times the water depth behind the first vessel. Since the invention may be used in deep water, say 1000 m in depth or more, it follows that the second vessel may be at least 1 or 2 km behind the first vessel.

The head waves detected will typically at least comprise P-waves and may further comprise S-waves. (Both such wave types will be produced under suitable conditions, as explained below.) For a given water depth, to enable S-waves to be detected, the second vessel will normally have to be a significantly greater distance behind the first vessel and hence the second seismic source will have to be more powerful to provide detectable signals. Since this distance increases with increased water depth, the option of detecting S-waves may be more preferable in shallower waters.

The reflection data gathered by the system can be used to obtain the acoustic impedance of the seabed. The refraction data can be used to obtain the seismic velocity of the seabed. Combining acoustic impedance and velocity, the density of the seabed can be estimated, as discussed further below.

Accordingly, the signals emitted by the second source are preferably used to determine the propagation velocity in the seabed or a parameter indicative thereof. Furthermore, the determined propagation velocity is preferably used in combination with a determined estimate of the co-efficient of reflection at the seabed to determine a value for the density of the sea bed.

It is known that sulphide deposits have a significantly different density from the basaltic sea bed within which they are often located. Accordingly, viewed from a further aspect, the invention provides a system as discussed above arranged to determine an estimate of the density of the sea bed and accordingly the likelihood of sulphide deposits being present.

The invention also extends to a corresponding method. Thus, according to a still further aspect of the invention there is provided a method of performing a seismic survey for prospecting for sub-sea minerals comprising: providing a first vessel having associated therewith a first seismic source and a seismic detector; providing a second vessel having associated therewith a second seismic source; emitting signals from both the first and second seismic sources; receiving using the seismic detector acoustic signals resulting from the reflection and/or refraction by the sea bed of acoustic signals emitted from both the first and second seismic sources.

As discussed above, the first and second seismic sources preferably emit simultaneous signals. The method may further comprise the use of the system, and particularly its preferred forms, as discussed above.

Furthermore, viewed from a still further aspect, the invention provides a method of prospecting for sub-sea deposits of hydrates comprising the use of the method or system discussed above.

Certain preferred embodiments of the present invention will now be described by way of example only with reference to the accompanying drawings, in which:

FIG. 1 is a Geological cross-section of the Solwara-1 sulphide deposit and stock work in the Bismarck Sea, PNG. (Figure courtesy of Nautilus Minerals Niugini Ltd (2018));

FIG. 2 is a schematic elevation of a conventional site-survey vessel with geophysical instrumentation;

FIG. 3 is a schematic elevation of a seismic survey system for seabed mineral exploration according to an embodiment of the invention;

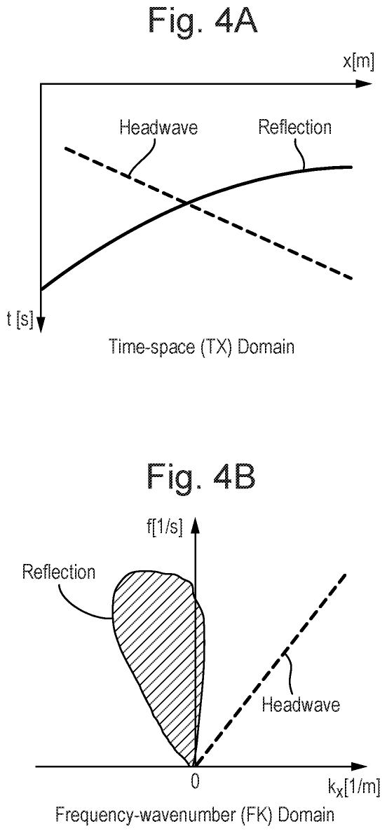

FIG. 4(a) is a plot of time (t) against distance (x) for waves respectively reflected directly from the sea bed and refracted along the sea bed FIG. 4(b) is a corresponding plot of frequency (f) against wavenumber (kₓ);

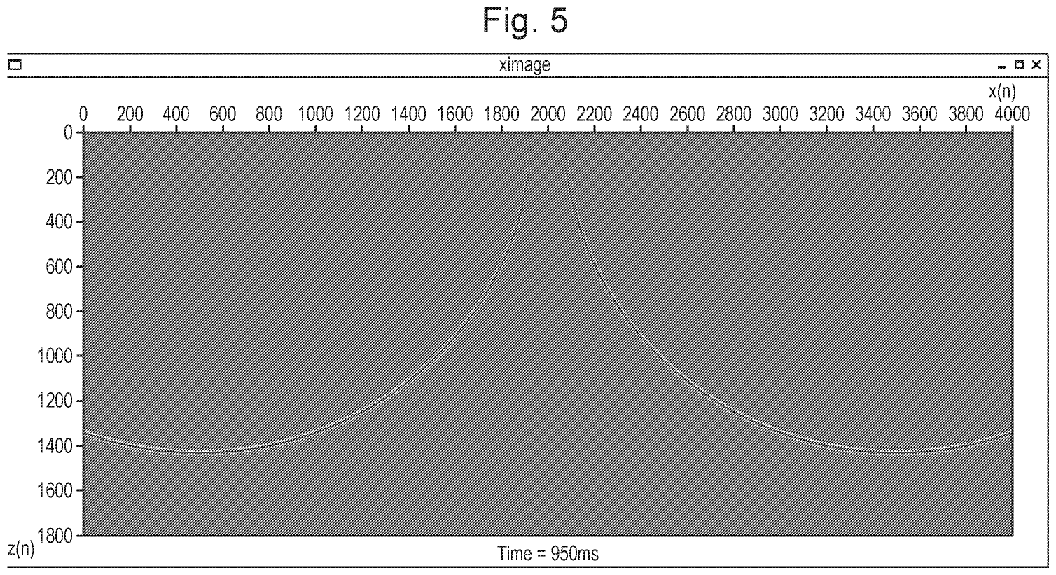

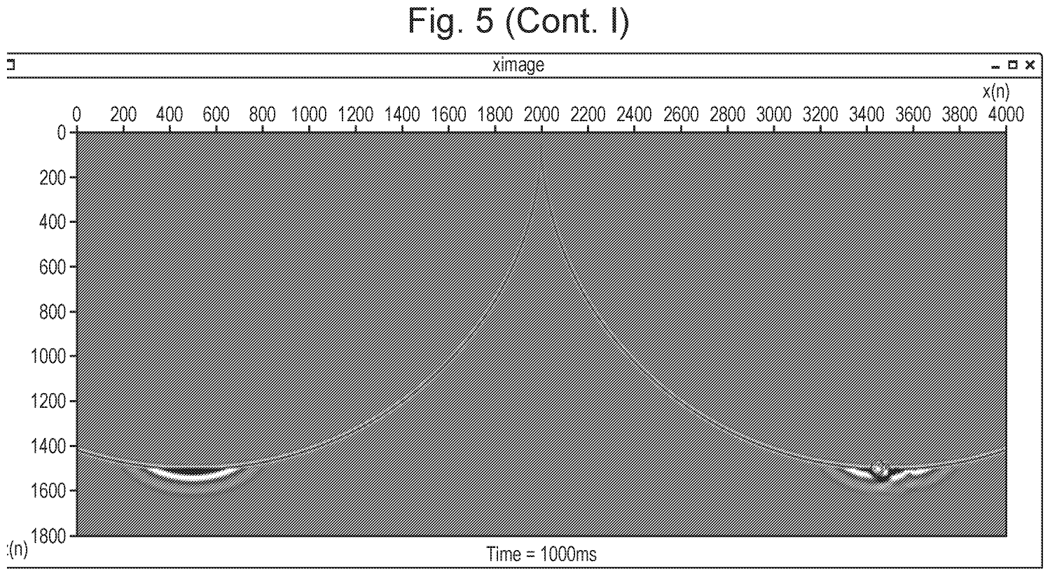

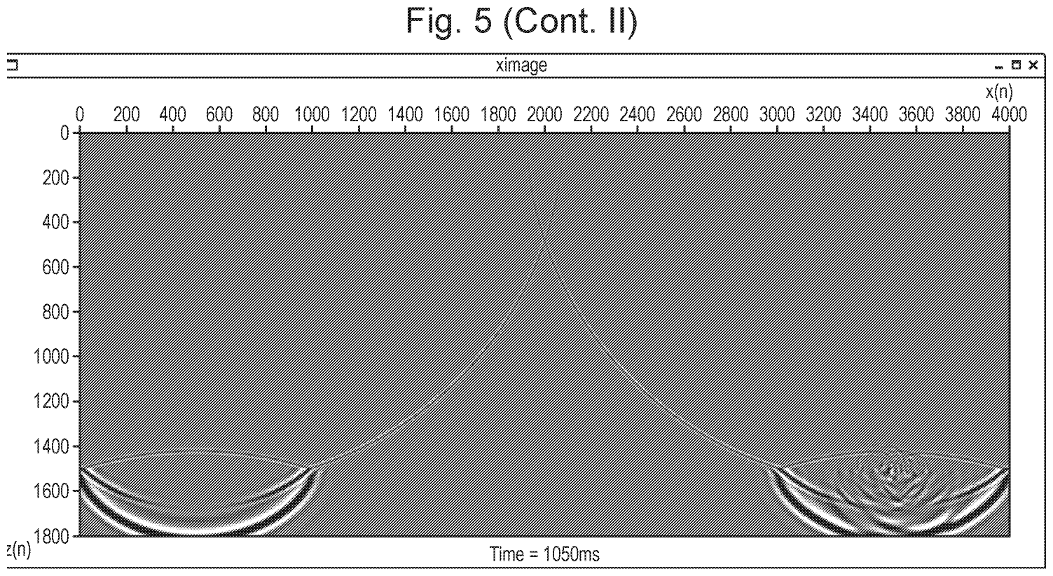

FIG. 5 is a set of snapshots from elastic 2D finite difference modelling with two simultaneous sources;

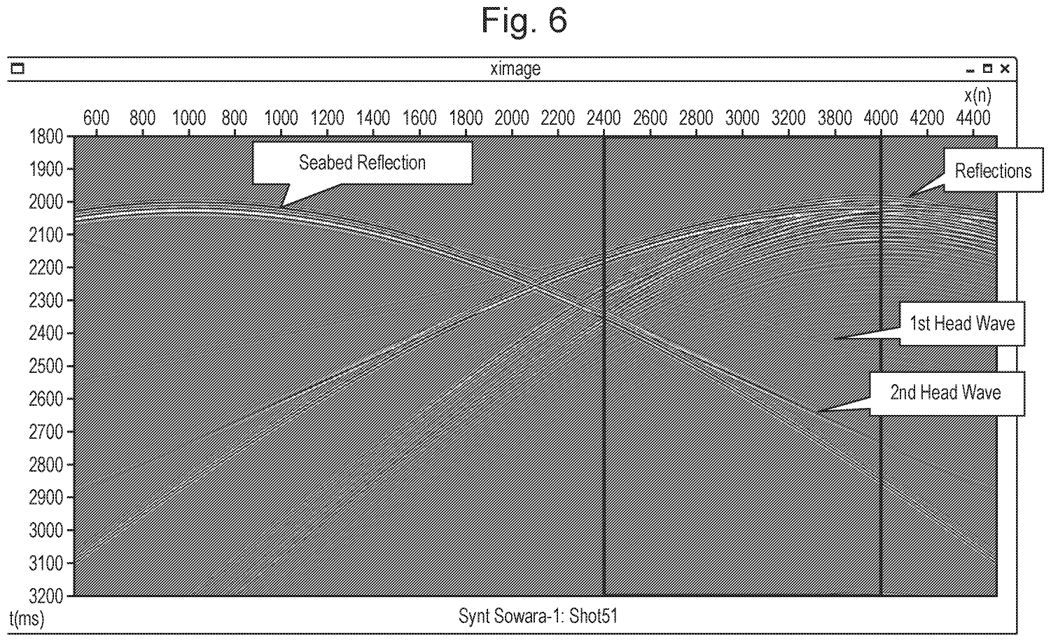

FIG. 6 is a snapshot of a seismic wavefield reaching the surface; and

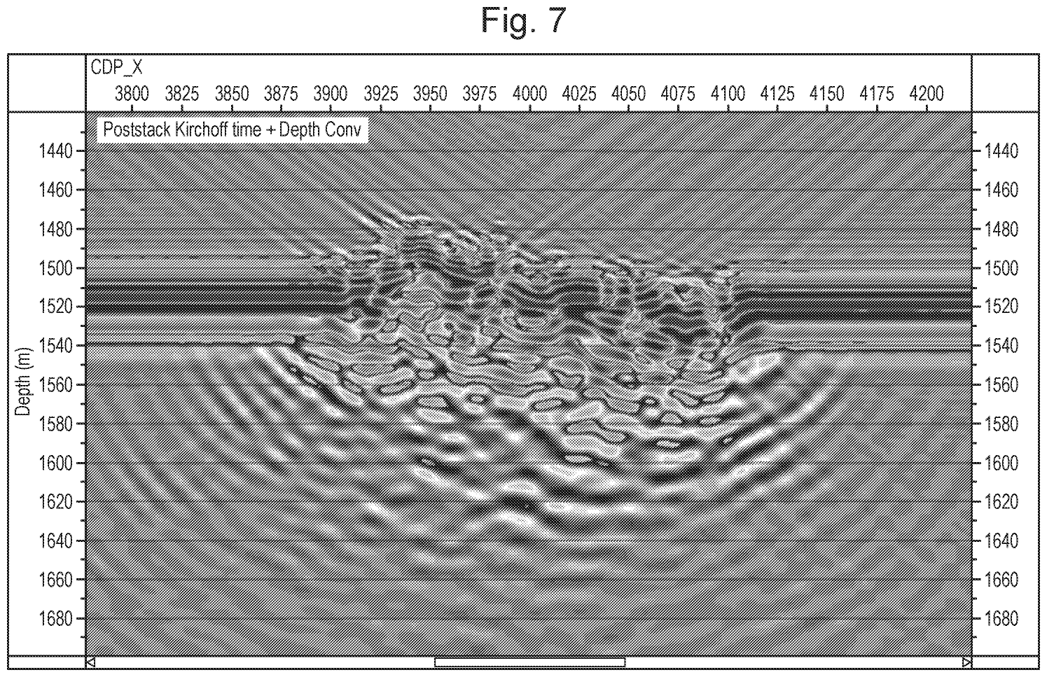

FIG. 7 is a seismic image computed by NMO stack.

Seabed sulphide accumulations are mostly located on oceanic crust along the mid-oceanic spreading ridges. The dominating lithology is basaltic and the sediment cover is usually thin (e.g. 0-50 m).

FIG. 1, shows an example of such a subsea sulphide deposit, which may be surveyed by embodiments of the present invention. The figure shows the lower part of the sea 1 above a volcanic region of the seabed comprising volcanic rock 2 having regions of clay-altered volcanics 3 above which is located a deposit of massive sulphides 4 in which pyrite and chalcopyrite are dominant. This is overlaid by a thin sediment 5. Such deposits of sulphides 4 are usually associated with precipitation from hydrothermal vents, typically those known as ‘black smokers’. Regions 6 are interpreted stockwork feeder zones which form the geological “plumbing” below the vents. The deposits are usually relatively small, typically 100-500 m in radius, and located in deep water (1500-4000 m).

FIG. 2 shows a known seismic site-survey system 10 for high-resolution mapping of the seabed and the shallow subsurface. Such systems are conventionally used to map geo-hazards, such as shallow gas, located (like formations such as that illustrated in FIG. 1) near the sea bed. As such, they are designed for shallow, high-resolution imaging.

Survey vessel 11 tows an ultra-high resolution (UHR) source 12 and a high resolution (HR) source 13, together with corresponding streamers—UHR streamer 14 and HR streamer 15. Seismic signals (i.e. acoustic waves) emitted from the sources 12 and 13 are directed towards the sea bed where they are reflected and/or refracted back towards detectors (hydrophones) mounted along the streamers 14, 15, in a manner well-known in the art. Since the highest spatial resolution is obtained by “zero-offset” reflection (i.e. at normal incidence), these are relatively short—i.e. up to 1500 m in length. In this example, the UHR has a 10 cubic inch source and the UHR streamer is 100 m long and 0.75 m deep.

The vessel also has a multi-beam echo sounder 16 (70-100 kHz), sub-bottom profiler 17 (peak frequency 3850 kHz) mounted to it and it tows a side scan sonar unit 18 (120-410 kHz).

FIG. 3 illustrates a system 20 according to an embodiment of the invention. The system 20 comprises a first survey vessel 21, towing a (first) seismic source 22 and a (first) streamer 23. The vessel may correspond to site survey vessel 11 of FIG. 2 and hence may be provided with further sources, streamers and/or other survey apparatus as shown in that figure.

The system 20 further comprises a second vessel (the “chase boat”) 24 towing a further (second) seismic source 25. However, it need not be provided with a streamer and is not so provided in the illustrated embodiment. The second vessel 24 follows the first vessel 21, separated from it by a significant distance. The criterion for determining the distance is that it has to be far enough for the second source 25 to cause head waves to be recorded by streamer 23 (see below), which depends on water depth and critical angles at the seabed.

In use, the first seismic source 22 emits signals 26 (shown as rays in the figure), which are reflected from the seabed 27 and the reflected waves 28 are then detected by acoustic detectors (not shown) arranged along streamer 23.

In addition, the second seismic source 25 emits signals 27 (shown as rays in the figure). Although these will be partially reflected by the sea bed 28, because of the distance of the second vessel from the streamer 23, they will not be detected to any significant degree because they will arrive too late. However, where the acoustic waves 27 strike the sea bed 28 at the relevant critical angle of incidence (see below), head waves 30 propagate along the sea bed for some distance before they result in return waves 31 “leaking” from the sea bed and being detected by the detectors on the streamer 23.

The two sources may be fired alternately (flip-flop), or simultaneously. In the case of flip-flop firing, the signals form the two sources can be separated based upon the timing of the firing. However, simultaneous shooting gives denser source spacing and/or higher operational efficiency. In this case, the data from reflected waves 28 and that from head-wave data 31 will be recorded with opposite slopes, such that separation of data in the frequency-wavenumber (FK) domain is straightforward. (Slope here refers to the slope of an event recorded in a seismogram, mathematically the slope is dt/dx.) This may be seen from FIG. 4, which shows the space-time domain (a) and the frequency-wavenumber domain (b). The x-direction is typically the heading direction of the boat. The two pairs of variables (t, x) and (f, k) are related by two-dimensional Fourier transform. The wavenumber is inversely proportional to wavelength (i.e. k=2π/λ)

Although acoustic signals can only propagate through water as longitudinal waves, it is well known that within the earth they can propagate both as longitudinal “P-waves” and as transverse (shear) “S-waves”. It is also well known that, where a wave strikes the boundary between different media at an angle of incidence (to the normal) which is less than a certain “critical” angle, the wave will be reflected to some degree. However, when it strikes at the critical angle, the wave will propagate along the boundary. In the context of seismic surveys, such waves propagate along the sea bed and are referred to as head waves (see ref. 30 of FIG. 3).

The critical angle depends on the ratio of the wave propagation velocities in the two media. Since P- and S-waves have different propagation velocities, it is possible for two head waves to be propagated, provided that the S-wave velocity is greater than the seismic wave propagation velocity in water. These will correspond to different angles of incidence of the acoustic waves from the source.

With reference to FIG. 3, the first source 22 emits acoustic waves 26 that strike the sea bed 30 at a small angle of incidence and are reflected back to the streamer 23. In contrast the acoustic waves emitted from source 25 which strike the sea bed 30 at the respective critical angles result in the propagation of P and S head waves 30 which travel along the sea bed before they are result in acoustic waves 31 being detected by the streamer 23.

The detection of S-waves is optional. For a given second seismic source 25, as the distance between vessels becomes too large (as required by deeper water), the first headwave will become too weak to be detected at the streamer 23.

Since the co-efficient of reflection depends on the density and propagation velocity of waves in the respective media and the critical angles depend only on the respective propagation velocities, it follows that, if the reflection coefficient is estimated from reflection seismic data, and P-wave (and optionally S-wave) velocity is computed from the first head wave, the density can be computed. Metal-sulphide deposits on the seabed will normally appear as anomalies with lower P- and S-wave velocities and often (depending on metal content) higher density than the background basalt lithology. Accordingly, the above-mentioned parameters may be used to predict the presence deposits of (metal) sulphides. In a typical application they are used in multi-geophysical inversion.

As discussed above, seabed sulphide accumulations are mostly located within a mainly basaltic lithology with thin sediment cover. As a result, the acoustic contrast between the sea water of the sea bed is large. The use of the invention to determine the relevant parameters will now be discussed in more detail.

The seismic P-wave velocity and density of sea water are, approximately:

V₀=1480 m/s

ρ₀=1030 kg/m3

Since shear waves cannot propagate in water, the S-wave velocity of water is zero. The seismic P- and S-wave velocities and density of basalt are approximately:

v_{P}=6000 m/s

v_{S}=3000 m/s

ρ=2900 kg/m3

The normal-incidence P-wave reflection coefficient of the seabed is, approximately:

$${R}_{0} \frac{ρ {v}_{P} {ρ}_{0} {v}_{0}}{ρ {v}_{P} ⋮ {ρ}_{0} {v}_{0}} \qquad ( 1 )$$

The first head wave is excited at the critical angle θ_{C1} given by:

$$sin {θ}_{C 1} \frac{{v}_{0}}{{v}_{P}} \qquad ( 2 )$$

The slope (see definition above) of the first head wave is inversely proportional to the P-wave velocity of the seabed. If v_{S}>v₀, the second head wave is excited at the critical angle θ_{C2} given by:

$$sin {θ}_{C 2} \frac{{v}_{0}}{{v}_{S}} \qquad ( 3 )$$

The slope of the second head wave is inversely proportional to the S-wave velocity of the seabed.

The inverse P and S wave velocities 1/vₚ and 1/vₛ can be computed from the slopes of the respective headwaves. R₀, the normal incidence reflection coefficient, may be estimated from the reflection data as it is approximately equal to the small-angle stack image from standard seismic processing. Using this information, a value for the density of the relevant portion of the seabed can be calculated. Comparing this to the value p for basalt may then be used to provide an indication of whether (metal) sulphides are likely to be present.

### Simulation

The use of the embodiment has been analysed using a synthetic modelling study. The “organ pipes” of the black smokers are too small to be accurately represented on the finite difference grid with the chosen grid spacing of DX=DZ=5 m. For simplicity, and to avoid grid diffractions, the seabed was horizontal. The water depth is 1500 m. Synthetic seismic data was obtained by 2D elastic finite difference modelling. A 2D seismic line was simulated with source interval of 10 m and a receiver line of 1200 m with 5 m receiver spacing. This gives a 2.5 m CDP interval, and a CMP fold of 60. Simultaneous seismic sources were simulated with the first source located in the front of the receiver line, and the second source located 4 km behind the first and 2.8 km behind the far-offset receiver position. The Source time function was a Ricker wavelet with a maximum frequency of 230 Hz, which is the typical range for site survey data.

Snapshots recorded at different time steps shows the wave field right before and right after it hits the seabed and the simulated metal sulphide target (FIG. 5). The snapshot shows simple P-wave reflections from the seabed, and diffractions from the target, including converted S-waves below the seabed. The increase in wavelength when the wavefield propagates below the seabed can be observed.

The seismic wavefield reaching the surface consist of reflected and diffracted P-waves, and the two different head waves with linear slopes in the space-time (XT) domain (FIG. 6). The red rectangle in the plot indicates the portion of the wave field that is recorded on a 1200 m receiver line for a shot record with two simultaneous sources, as discussed above.

Seismic processing and imaging were performed using a simple processing sequence in the SeisSpace processing software, as follows:

1. CMP sort and NMO correction

2. CMP stack

3. Post-stack Kirchhoff time migration

4. Vertical-stretch depth conversion

The seismic image shows the seabed and the target, with internal structure of the target only partly resolved (FIG. 7). The image can be improved by more sophisticated imaging, e.g. prestack depth migration. There is, however, a fundamental in the resolution given by the maximum frequency and the size of the target.

I claim:

1. A seismic survey system for prospecting for sub-sea minerals comprising: a first vessel having associated therewith a first seismic source and a seismic detector; and a second vessel having associated therewith a second seismic source; wherein the seismic detector is arranged to receive acoustic signals resulting from the reflection and/or refraction by the sea bed of acoustic signals emitted from both the first and second seismic sources.

2. A system as claimed in claim 1, the seismic detector is a streamer comprising a plurality of hydrophones towed by the first vessel.

3. A system as claimed in claim 1, wherein the second vessel is located behind the first vessel in the direction of travel thereof and is at a distance greater than 1.5×the water depth behind the first vessel.

4. A system as claimed in claim 1, wherein the firing of the first and second seismic sources is synchronized.

5. A system as claimed in claim 1, wherein the first and second seismic sources fire simultaneously.

6. A system as claimed in claim 1, wherein the seismic detector is arranged to detect acoustic signals emitted by the first source and reflected by the sea bed to the seismic detector.

7. A system as claimed in claim 1, wherein the seismic detector is arranged to detect acoustic signals emitted by the second source and propagated along the sea bed as head waves prior to detection by the seismic detector.

8. A system as claimed in any claim 7, wherein the head waves comprise P-waves.

9. A system as claimed in claim 7, wherein the signals emitted by the second source are used to determine the propagation velocity in the seabed or a parameter indicative thereof.

10. A system as claimed in claim 9, wherein the determined propagation velocity is used in combination with a determined estimate of the co-efficient of reflection at the seabed to determine a value for the density of the sea bed.

11. A system as claimed in claim 1 arranged to determine an estimate of the density of the sea bed and accordingly the likelihood of sulphide deposits being present.

12. A system as claimed in claim 1, wherein the second vessel is a site-survey vessel.

13. A method of performing a seismic survey for prospecting for sub-sea minerals comprising:
a. providing a first vessel having associated therewith a first seismic source and a seismic detector
b. providing a second vessel having associated therewith a second seismic source;
c. emitting signals from both the first and second seismic sources;
d. receiving using the seismic detector acoustic signals resulting from the reflection and/or refraction by the sea bed of acoustic signals emitted from both the first and second seismic sources.

14. A method as claimed in claim 13, wherein the first and second seismic sources emit simultaneous signals.

15. A method as claimed in claim 13 using the system of claim 1.

16. A method of prospecting for sub-sea deposits of sulphides comprising the use of the system of claim 1.

17. A system as claimed in any claim 8, wherein the head waves further comprise S-waves.
